(19) United States
(12) Patent Application Publication
(10) Pub. No.: US 2025/0142364 A1
(43) Pub. Date: May 1, 2025

(54) RADIO RESOURCE MANAGEMENT (RRM) ENHANCEMENTS FOR SOUNDING REFERENCE SIGNAL (SRS) ANTENNA SWITCHING

(71) Applicant: Apple Inc., Cupertino, CA (US)

(72) Inventors: Manasa Raghavan, Sunnyvale, CA (US); Jie Cui, San Jose, CA (US); Qiming Li, Beijing (CN); Yang Tang, San Jose, CA (US); Xiang Chen, Campbell, CA (US); Haitong Sun, Cupertino, CA (US)

(73) Assignee: Apple Inc., Cupertino, CA (US)

(21) Appl. No.: 18/885,118

(22) Filed: Sep. 13, 2024

Related U.S. Application Data
(60) Provisional application No. 63/546,576, filed on Oct. 31, 2023.

(51) Int. Cl. H04W 24/02; H04L 5/00; H04W 72/21

(52) U.S. Cl. CPC H04W 24/02; H04L 5/0051; H04W 72/21

(57) ABSTRACT

Some aspects of this disclosure relate to apparatuses and methods for implementing mechanisms for reducing interruption lengths for Sounding Reference Signal (SRS) antenna switching. For example, some aspects of this disclosure relate to a user equipment (UE) configured to determine one or more symbols during which the UE is configured to perform an antenna switch for a Sounding Reference Signal (SRS) transmission. The UE is further configured to generate an indication message including an indication of the one or more symbols and transmit, using the transceiver, the indication message to the base station.

### CROSS-REFERENCE TO RELATED APPLICATIONS

The present application claims the benefit of U.S. Provisional Patent Application No. 63/546,576, filed on Oct. 31, 2023, which is incorporated by reference herein in its entirety.

### BACKGROUND

### Field

The described aspects generally relate to mechanisms for a network to reduce interruptions for Sounding Reference Signal (SRS) antenna switching.

### Related Art

A user equipment (UE) transmits a Sounding Reference Signal (SRS) to a base station to help the base station determine the channel quality of an uplink channel from the UE to the base station. The SRS is a reference signal transmitted using an SRS resource. The SRS resource can include the location of the SRS in time and frequency domain in a resource grid. In some implementations, the parameters for the SRS resource and/or SRS transmission can be determined by the base station, and can be communicated to the UE. However, transient periods for UE antenna switching before and after the SRS transmissions are not known to the base station. Therefore, the base station may use large interruption periods where no uplink (UL) and downlink (DL) transmission is performed to anticipate the UE SRS antenna switching.

### SUMMARY

Some aspects of this disclosure relate to apparatuses and methods for implementing mechanisms for reducing interruption lengths for Sounding Reference Signal (SRS) antenna switching. Radio Resource Management (RRM) enhancements for the SRS antenna switching are provided to improve network operations during, for example, UE antenna switching for SRS transmissions.

Some aspects of this disclosure relate to a user equipment (UE). The UE includes a transceiver configured to enable wireless communication with a base station and a processor communicatively coupled to the transceiver. The processor is configured to determine one or more symbols during which the UE is configured to perform an antenna switch for a Sounding Reference Signal (SRS) transmission. The processor is further configured to generate an indication message including an indication of the one or more symbols and transmit, using the transceiver, the indication message to the base station.

In some aspects, the indication message includes at least one of a Radio Resource Control (RRC) message, a Medium Access Control (MAC) Control Element (MAC-CE), or a Uplink Control Information (UCI).

In some aspects, the indication identifies one or more symbols before the SRS transmission during which the UE is configured to perform the antenna switch. The indication further identifies one or more symbols after the SRS transmission during which the UE is configured to perform the antenna switch.

In some aspects, the indication includes a symbol level bitmap for indicating the one or more symbols during which the UE is configured to perform the antenna switch.

In some aspects, the processor is further configured to switch from a first antenna to a second antenna during a first set of symbols of the one or more symbols and use the second antenna for the SRS transmission. The processor is further configured to switch to the first antenna during a second set of symbols of the one or more symbols.

In some aspects, the indication includes two or more antenna switching patterns based on a number of SRS symbols of the SRS transmission and a start symbol the SRS transmission. In some aspects, the indication message includes a Radio Resource Control (RRC) message indicating that the UE having two or more antenna switching patterns and one or more of a Medium Access Control (MAC) Control Element (MAC-CE) or a Uplink Control Information (UCI) indicating a specific antenna switching pattern of the two or more antenna switching patterns.

Some aspects of this disclosure relate to a method including determining one or more symbols during which a user equipment (UE) is configured to perform an antenna switch for a Sounding Reference Signal (SRS) transmission. The method further includes generating an indication message including an indication of the one or more symbols and transmitting the indication message to a base station.

Some aspects of this disclosure relate to a non-transitory computer-readable medium storing instructions. When the instructions are executed by a processor of a user equipment (UE), cause the UE to perform operations including determining a plurality of symbols during which the UE is configured to perform an antenna switch for a Sounding Reference Signal (SRS) transmission. The operations further include generating an indication message including an indication of the plurality of symbols and transmitting the indication message to a base station.

Some aspects of this disclosure relate to a base station. The base station includes a transceiver configured to enable wireless communication with a user equipment (UE) and a processor communicatively coupled to the transceiver. The processor is configured to receive, using the transceiver and from the UE, an indication message including an indication of one or more symbols during which the UE is configured to perform an antenna switch for a Sounding Reference Signal (SRS) transmission. The processor is further configured to refrain from transmitting a downlink (DL) signal to the UE during the one or more symbols.

In some aspects, the processor is further configured to use the indication and timing advance information to determine the one or more symbols for refraining from transmitting DL signal(s) to the UE.

Some aspects of this disclosure relate to a method including receiving, by a base station and from a user equipment (UE), an indication message including an indication of one or more symbols during which the UE is configured to perform an antenna switch for a Sounding Reference Signal (SRS) transmission. The method further includes refraining from transmitting a downlink (DL) signal to the UE during the one or more symbols.

Some aspects of this disclosure relate to a non-transitory computer-readable medium storing instructions. When the instructions are executed by a processor of a base station, cause the base station to perform operations including receiving, from a user equipment (UE), an indication message including an indication of one or more symbols during which the UE is configured to perform an antenna switch for a Sounding Reference Signal (SRS) transmission. The method further includes refraining from transmitting a downlink (DL) signal to the UE during the one or more symbols.

This Summary is provided merely for purposes of illustrating some aspects to provide an understanding of the subject matter described herein. Accordingly, the above-described features are merely examples and should not be construed to narrow the scope or spirit of the subject matter in this disclosure. Other features, aspects, and advantages of this disclosure will become apparent from the following Detailed Description, Figures, and Claims.

### BRIEF DESCRIPTION OF THE FIGURES

The accompanying drawings, which are incorporated herein and form part of the specification, illustrate the present disclosure and, together with the description, further serve to explain the principles of the disclosure and enable a person of skill in the relevant art(s) to make and use the disclosure.

FIG. 1 illustrates an example system implementing mechanisms for a network to implement mechanisms for Radio Resource Management (RRM) enhancements for Sounding Reference Signal (SRS) antenna switching, according to some aspects.

FIG. 2 illustrates a block diagram of an example system of an electronic device implementing mechanisms for RRM enhancements for SRS antenna switching, according to some aspects.

FIGS. 3A-3C illustrate example SRS and transient periods used for SRS antenna switching, according to some aspects.

FIG. 4 illustrates an example method for a system (for example, a UE) supporting mechanisms for RRM enhancements for SRS antenna switching, according to some aspects.

FIG. 5 illustrates an example method for a system (for example, a base station) supporting mechanisms for RRM enhancements for SRS antenna switching, according to some aspects.

FIG. 6 is an example computer system that can be used for implementing some aspects or portion(s) thereof.

The present disclosure is described with reference to the accompanying drawings. In the drawings, generally, like reference numbers indicate identical or functionally similar elements. Additionally, generally, the left-most digit(s) of a reference number identifies the drawing in which the reference number first appears.

### DETAILED DESCRIPTION

Some aspects of this disclosure relate to apparatuses and methods for implementing mechanisms for reducing interruption lengths for Sounding Reference Signal (SRS) antenna switching. Radio Resource Management (RRM) enhancements for the SRS antenna switching are provided to improve network operations during, for example, UE antenna switching for SRS transmissions.

In some examples, the aspects of this disclosure can be performed by a network and/or a UE that operates according to 5^{th} generation (5G) wireless technology and/or new radio (NR) of 5G wireless technology for digital cellular networks as defined by 3rd Generation Partnership Project (3GPP). Additionally, or alternatively, the aspects of this disclosure can be performed by a network and/or a UE that operates according to the Release 18 (Rel-18), Release 17 (Rel-17), Release 16 (Rel-16), and Release 15 (Rel-15), or others. However, the aspects of this disclosure are not limited to these examples, and one or more mechanisms of this disclosure can be implemented by other network(s) and/or UE(s) for using an indication message or signal to indicate UE SRS antenna switching.

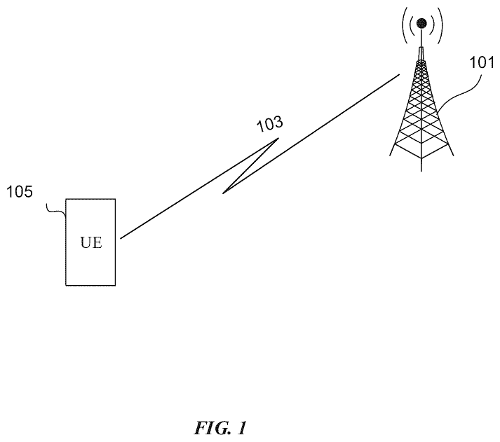

FIG. 1 illustrates an example system 100 implementing mechanisms for RRM enhancements for SRS antenna switching, according to some aspects of the disclosure. Example system 100 is provided for the purpose of illustration only and does not limit the disclosed aspects.

System 100 may include, but is not limited to, one or more base stations 101 (for example, a base station such as eNBs, gNBs, and the like) and one or more electronic devices (for example, a UE) 105. The electronic device 105 (hereinafter referred to as UE 105) can be configured to operate based on a wide variety of wireless communication techniques. These techniques can include, but are not limited to, techniques based on 3 rd Generation Partnership Project (3GPP) standards. For example, the UE 105 can include an electronic device configured to operate using NR, Rel-18, Rel-17, and/or other releases of 3GPP standards. The UE 105 can include, but is not limited to, as wireless communication devices, smart phones, laptops, desktops, tablets, personal assistants, monitors, televisions, wearable devices, Internet of Things (IoTs), vehicle's communication devices, and the like.

The base station 101 (herein referred to as base station or cell) can include nodes configured to operate based on a wide variety of wireless communication techniques such as, but not limited to, techniques based on 3G standards. For example, the base station 101 can include nodes configured to operate using NR, Rel-18, Rel-17, and/or other releases of 3G standards.

According to some aspects, the UE 105 can be connected to and can be communicating with the base station 101 using a carrier 103. According to some aspects, the carrier 102 can include one carrier. Additionally, or alternatively, the carrier 102 can include two or more component carriers (CC). In other words, the UE 105 can implement carrier aggregation (CA). For example, the UE 105 can use multiple carriers for communication with the base station 101.

According to some aspects, the UE 105 can be configured to transmit SRS to the base station 101. The SRS can help, for example, the base station 101 to determine the channel quality of an uplink channel from the UE 105 to the base station 101. For example, the SRS can be used for uplink channel sounding, which can include, but is not limited to, channel estimation and synchronization. The SRS can be an uplink orthogonal frequency division multiplexing (OFDM) signal filled with a Zadoff-Chu sequence on different subcarriers. According to some implementations, the SRS is known by both the UE 105 and the base station 101.

The UE 105 can transmit the SRS during one or more SRS transmission occasions (e.g., SRS resources). The SRS transmission occasion (e.g., the SRS resource) can include the location of the SRS in a time and frequency domain in a resource grid. In some implementations, the SRS transmission occasion can include one or more resource elements. In some implementations, the parameters for the SRS transmission occasion and/or the SRS transmission can be determined by the base station 101, and can be communicated to the UE 105.

In some examples (e.g., in Rel-15), the SRS can only be transmitted in the last 6 symbols of each slot, and the SRS can be repeated up to 4 symbols. In some examples (e.g., in Rel-16), the SRS can be transmitted in any symbol in a slot, and the SRS can support repetition with 8 and 12 symbols. In some examples (e.g., in Rel-17), flexible aperiodic (AP) SRS triggering can be supported. Also, Resource Block (RB) level Partial Frequency Sounding (RPFS) can be supported. Additionally, SRS repetition with 10 and 14 symbols can be supported. In some implementations in Rel-17, Channel State Information (CSI) feedback is further enhanced for NCJT (Non-coherent Joint Transmission) for Multi-TRP. The enhancement can be based on Type I MIMO codebook and it can only support the Single-DCI Multi-TRP NCJT scheme 1a (e.g., SDM (spatial domain multiplexing)), according to some implementations. Some examples (e.g., Rel-19) can support full slot SRS.

In the above examples, interruption requirements were introduced for SRS antenna switching. The UE (e.g., the UE 105) switches its antenna before the SRS transmission. The UE transmits the SRS and then the UE switches back its antenna after the SRS transmission. However, transient periods for UE antenna switching before and after the SRS transmissions are not known to the base station (e.g., the base station 101). Therefore, the base station may use large interruption periods where no uplink (UL) and downlink (DL) transmission is performed to anticipate the UE SRS antenna switching. Depending on different implementations, the interruption requirements can cover SRS transmission in last 6 symbols of a slot, the interruption requirements can cover SRS transmission in any symbol of the slot, or the interruption requirements can cover full slot SRS transmission. For example, for Rel 17, the interruption requirements are defined at a slot level where an assumption is that the SRS is in the last 6 symbols of the slot

The uncertainty of when the UE starts the antenna switch for the SRS transmission and/or how long the antenna switch can last leads to long interruption time where no DL and/or UL transmissions occur. With SRS start symbol being in any slot, larger interruption length might need to be introduced that leads to long interruption lengths and loss of resources for transmission. The interruption are usually due to uncertainty.

As discussed in more detail below, some aspects of this disclosure relate to apparatuses and methods for implementing mechanisms for reducing interruption lengths for the SRS antenna switching. The RRM enhancements for the SRS antenna switching are provided to improve network operations during, for example, UE antenna switching for SRS transmissions by decreasing the amount of time the base station interrupts its DL and/or UL transmissions.

According to some aspects, the UE 105 is configured to transmit SRS to the base station 101 to help, for example, the base station 101 to determine the channel quality of an uplink channel from the UE 105 to the base station 101. The UE 105 can have multiple antenna. In some aspects, when the number of UE transmission (TX) antennas is less than the number of UE reception (RX) antennas, the UE 105 can use antenna switching for transmitting SRS. In one example, the TX and RX antennas of the UE 105 can be indicated as xTyR where x indicates the number of TX antenna port and y indicates the number of RX antenna port and where the TX and RX are from the point of UE 105.

According to some aspects, the UE 105 uses a first antenna (e.g., a first antenna port) while the UE 105 is communicating with the base station 101. For transmitting the SRS (and before transmitting the SRS), the UE 105 can switch to a second antenna (e.g., a second antenna port) different from the first antenna. The UE 105 uses the second antenna to transmit the SRS. After transmitting the SRS, the UE 105 switches to a third antenna (e.g., a third antenna port). In some implementations, the third antenna can be the same as the first antenna. In some implementations, the third antenna can be different than the first antenna and the second antenna.

According to some aspects, during the transient periods (e.g., when the UE 105 is performing UE antenna switch (also referred to herein as antenna port switch) for SRS transmission), no UL and/or DL transmission is performed. The transient period is used for UE antenna switching before and after the SRS transmission.

According to some aspects, the one or more SRS transmission occasions (e.g., SRS resources) used for transmitting the SRS are known by the UE 105 and the base station 101. For example, the base station 101 can configure and communicate the one or more SRS transmission occasions to the UE 105 during the Radio Resource Control (RRC) setup and/or RRC reconfiguration. The base station 101 can communicate the one or more SRS transmission occasions to the UE 105 using other methods too.

Depending on the UE 105 capability, TX/RX configurations, and/or TX/RX antenna configurations, the UE 105 can determine the resources the UE 105 uses for antenna switching for SRS transmission. The UE 105 can additionally use information about the one or more SRS transmission occasions to determine the resources the UE 105 uses for antenna switching for SRS transmission. In some examples, the resources the UE 105 uses for antenna switching for SRS transmission can include one or more symbols before the SRS transmission and one or more symbols after the SRS transmission. However, other resources can also be used.

After determining the resources the UE 105 uses for antenna switching for SRS transmission, the UE 105 can communicate an indication of these resource to the base station 101. In other words, the UE 105 can communicate to the base station 101 when (and/or for how long) the UE 105 performs the antenna switching for SRS transmission. By knowing the resources the UE 105 uses for antenna switching for SRS transmission, the base station 101 knows the transient periods when the UE 105 would be unavailable. The base station 101 can refrain from transmitting DL signals (e.g., DL data frames such as Physical Data Shared Channel (PDSCH), DL control frames such as Physical Downlink Control Channel (PDCCH), Channel State Information Reference Signal (CSI-RS), or the like) to the UE 105 during the indicated resources when the UE 105 is performing antenna switching. Therefore, the interruptions for the base station 101 are minimized as the base station 101 knows the transient periods when the UE 105 is unavailable.

According to some aspects, the UE 105 can transmit the indication of the resources the UE 105 uses for antenna switching for SRS transmission using one or more indication messages. For example, the UE 105 can use RRC message(s) to transmit the indication of the resources the UE 105 uses for antenna switching for SRS transmission. For example, the UE 105 can use messages during the RRC setup and/or RRC reconfiguration to transmit the indication of the resources.

Additionally, or alternatively, the UE 105 can use Medium Access Control (MAC) Control Element (MAC-CE) to transmit the indication of these resources. The MAC-CE can carry control information such as the indication of the resources the UE 105 uses for antenna switching for SRS transmission.

Additionally, or alternatively, the UE 105 can use Uplink Control Information (UCI) to transmit the indication of these resources. The UCI can carry control information such as the indication of the resources the UE 105 uses for antenna switching for SRS transmission. In some examples, Physical Uplink Control Channel (PUCCH) can be used to carry the UCI.

However, the aspects of this disclosure are not limited to these examples, and other message can be used to carry the indication of the resources the UE 105 uses for antenna switching for SRS transmission.

According to some aspects, the indication of the resources the UE 105 uses for antenna switching for SRS transmission can identify one or more symbols prior to the start of the SRS transmission. The indication of the resources the UE 105 uses for antenna switching for SRS transmission can identify one or more symbols after the SRS transmission period. The number of one or more symbols prior to the start of the SRS transmission can be the same as the number of one or more symbols after the SRS transmission period. The number of one or more symbols prior to the start of the SRS transmission can be different from the number of one or more symbols after the SRS transmission period.

According to some aspects, the indication of the resources the UE 105 uses for antenna switching for SRS transmission can include a symbol level bit map to indicate the symbols the UE 105 will use for antenna switching.

In some examples, one symbol is enough for the antenna switching. In some examples, two or more symbols are used for the antenna switching. In these examples, the indication of the resources the UE 105 uses for antenna switching for SRS transmission can include a first duration of symbols for the symbols prior to the start of the SRS transmission and a second duration of symbols for the symbols after the SRS transmission period. The first duration can be the same as the second duration. The first duration can be different from the second duration.

According to some aspects, the UE 105 can be configured to use different antenna switching patterns. For example, the UE 105 can use different antenna switching patterns based on the number of SRS symbols and the start of the SRS transmission. For example, the UE 105 can use a first antenna switching pattern for SRS transmission having a first period (e.g., having a first number of SRS symbols) and a first start symbol for the SRS transmission. The UE 105 can use a second antenna switching pattern for SRS transmission having a second period (e.g., having a second number of SRS symbols) and a second start symbol for the SRS transmission. The first antenna switching pattern is different from the second antenna switching pattern.

Each switching pattern can identify one or more symbols during which the UE is configured to perform the antenna switch for the corresponding SRS transmission. The one or more symbols can be identified in terms of respective symbol location(s) within a slot. Additionally, or alternatively, each switching pattern can include a symbol level bitmap for the corresponding SRS transmission for identifying the one or more symbols during which the UE is configured to perform the antenna switch

The UE 105 can have one or more antenna switching patterns. The UE can use other parameters (in addition to or instead of the number of SRS symbols and the start of the SRS transmission) for determining the antenna switching patterns.

When using different antenna switching patterns, the UE 105 can indicate the antenna switching patterns to the base station using the indication message(s) discussed above. For example, the UE 105 can use RRC message(s) to indicate the antenna switching pattern. The UE 105 can use MAC-CE or UCI to indicate the antenna switching patterns. In some examples, the UE 105 can use the RRC message(s) to indicate to the base station 101 that the UE 105 is configured to use multiple antenna switching patterns. Then, the UE 105 can use MAC-CE or UCI for dynamic indication of specific antenna switching pattern based on applicable SRS transmission.

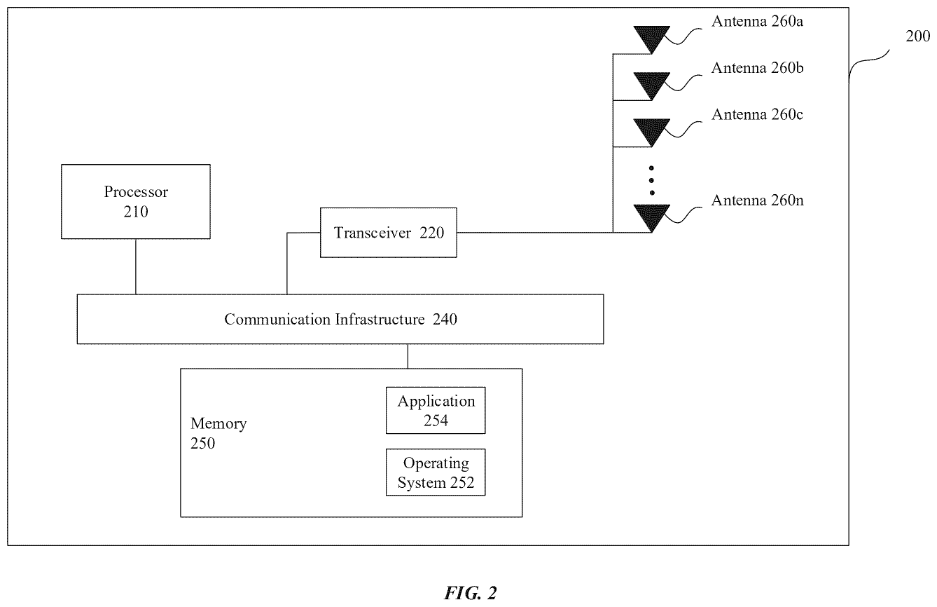

FIG. 2 illustrates a block diagram of an example system 200 of an electronic device implementing mechanisms for RRM enhancements for SRS antenna switching, according to some aspects of the disclosure. System 200 may be any of the electronic devices (e.g., the base station 101 and/or the UE 105) of system 100. The system 200 (e.g., a wireless system) includes at least a processor 210, one or more transceivers 220, a communication infrastructure 240, a memory 250, an operating system 252, an application 254, and one or more antennas 260a-260b. Illustrated systems are provided as exemplary parts of the system 200, and the system 200 can include other circuit(s) and subsystem(s). Also, although the systems of the system 200 are illustrated as separate components, the aspects of this disclosure can include any combination of these, fewer, more, and/or different components.

The memory 250 may include random access memory (RAM) and/or cache, and may include control logic (e.g., computer software) and/or data. The memory 250 may include other storage devices or memory such as, but not limited to, a hard disk drive and/or a removable storage device/unit. According to some examples, the operating system 252 can be stored in the memory 250. The operating system 252 can manage transfer of data from the memory 250 and/or one or more applications 254 to the processor 210 and/or one or more transceivers 220. In some examples, the operating system 252 maintains one or more network protocol stacks (e.g., Internet protocol stack, cellular protocol stack, and the like) that can include a number of logical layers. At corresponding layers of the protocol stack, the operating system 252 includes control mechanism and data structures to perform the functions associated with that layer.

According to some examples, the application 254 can be stored in the memory 250. The application 254 can include applications (e.g., user applications) used by the system 200 and/or a user of the system 200. The applications in application 254 can include applications such as, but not limited to, audio streaming, video streaming, remote control, and/or other user applications.

The system 200 can also include the communication infrastructure 240. The communication infrastructure 240 provides communication between, for example, the processor 210, one or more transceivers 220, and the memory 250. In some implementations, the communication infrastructure 240 may be a bus. The processor 210 together with instructions stored in the memory 250 performs operations enabling the system 200 of system 100 to implement mechanisms for RRM enhancements for SRS antenna switching, as described herein. Additionally, or alternatively, the one or more transceivers 220 perform operations enabling the system 200 of system 100 to implement mechanisms for RRM enhancements for SRS antenna switching.

The one or more transceivers 220 transmit and receive communications signals that support mechanisms for RRM enhancements for SRS antenna switching, according to some aspects, and may be coupled to the antennas 260a-260n. The antennas 260a-260n may include one or more antennas that may be the same or different types. The one or more transceivers 220 allow the system 200 to communicate with other devices that may be wired and/or wireless. In some examples, the one or more transceivers 220 can include processors, controllers, radios, sockets, plugs, buffers, and like circuits/devices used for connecting to and communication on networks. According to some examples, the one or more transceivers 220 include one or more circuits to connect to and communicate on wired and/or wireless networks.

According to some aspects, the one or more transceivers 220 can include a cellular subsystem, a WLAN subsystem, and/or a Bluetooth™ subsystem, each including its own radio transceiver and protocol(s) as will be understood by those skilled arts based on the discussion provided herein. In some implementations, the one or more transceivers 220 can include more or fewer systems for communicating with other devices.

In some examples, the one or more transceivers 220 can include one or more circuits (including a WLAN transceiver) to enable connection(s) and communication over WLAN networks such as, but not limited to, networks based on standards described in IEEE 802.11. Additionally, or alternatively, the one or more transceivers 220 can include one or more circuits (including a Bluetooth™ transceiver) to enable connection(s) and communication based on, for example, Bluetooth™ protocol, the Bluetooth™ Low Energy protocol, or the Bluetooth™ Low Energy Long Range protocol.

Additionally, the one or more transceivers 220 can include one or more circuits (including a cellular transceiver) for connecting to and communicating on cellular networks. The cellular networks can include, but are not limited to, 3G/4G/5G networks such as Universal Mobile Telecommunications System (UMTS), Long-Term Evolution (LTE), and the like. For example, the one or more transceivers 220 can be configured to operate according to one or more of Rel-15, Rel-16, Rel-17, Rel-18, NR, or other of the 3G standards.

According to some aspects, the processor 210, alone or in combination with computer instructions stored within the memory 250, the one or more transceivers 220, and/or antennas 260a-260n implements mechanisms for RRM enhancements for SRS antenna switching, as discussed herein. For example, the processor 210, alone or in combination with computer instructions stored within the memory 250, and/or the one or more transceivers 220 implement mechanisms for switching between the antennas 260a-260n before and after SRS transmissions, as discussed herein.

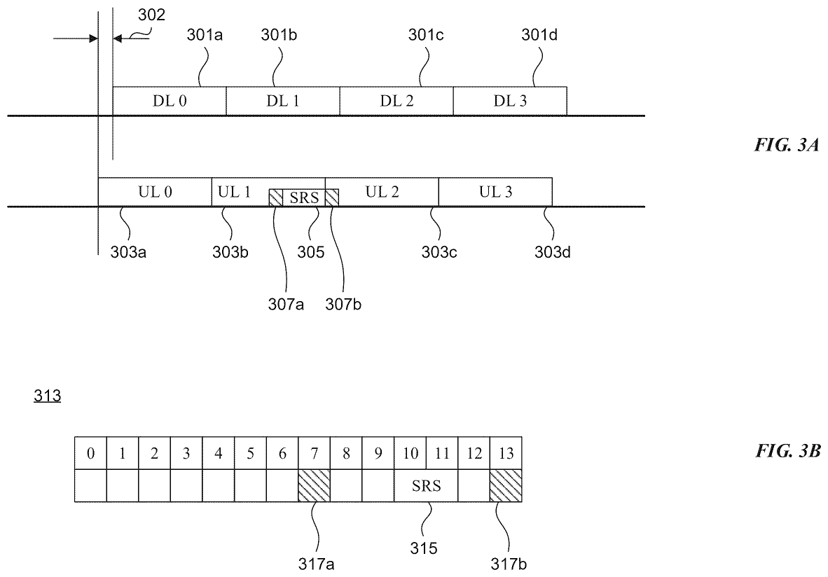

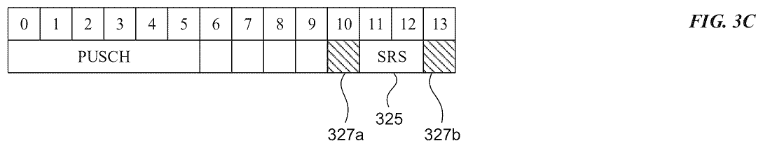

FIGS. 3A-3C illustrate example SRS and transient periods used for SRS antenna switching, according to some aspects.

FIG. 3A illustrates downlink (DL) slots 301a-301d. The DL slots 301a-301d (also collectively referred to as DL slots 301) are used by the base station (e.g., the base station 101 of FIG. 1) to transmit DL signals (e.g., DL data frames, DL control frames, or the like). FIG. 3A also illustrates uplink (UL) slots 303a-303d. The UL slots 303a-303d (also collectively referred to as UL slots 303) are used by the UE (e.g., the UE 105) to transmit UL signals (e.g., UL data frames, UL control frames, or the like). According to some aspects, each of the DL slots 301 and/or each of the UL slots 303 can include one or more symbols in the time domain.

FIG. 3A also illustrates a timing adjustment 302 between the DL slots 301 and the UL slots 303. The timing adjustment 302 can be based on a Timing Advance (TA) command. The TA command is a command from the base station to the UE that enables the UE to adjust its uplink transmission. The timing adjustment 302 (based on the TA command) can be used for UL adjustment for Physical Uplink Shared Channel (PUSCH), PUCCH, and/or SRS.

As illustrated in FIG. 3A, the UE may be scheduled and/or configured to transmit the SRS 305 during the UL slot 303b. The UE may perform an antenna switching before transmitting the SRS 305. In this example, the UE performs the antenna switching during symbol(s) 307a and symbol(s) 307b. For example, the UE is using a first antenna (e.g., a first antenna port) during UL slots 303a and 303b before the symbol(s) 307a. During the symbol(s) 307a, the UE switches to a second antenna (e.g., a second antenna port) that is different from the first antenna. The UE transmits the SRS 305 using the second antenna. During symbol(s) 307b, the UE switches to a third antenna (e.g., a third antenna port). According to some aspects, the third antenna is the same as the first antenna. After symbol(s) 307b, the UE uses the third antenna during UL slots 303c and 303d. In this example, the antenna switching symbols 307a and 307b (e.g., the transient periods) are immediately before and after the SRS 305 (e.g., the switching symbols 307a and 307b are immediately before and after the symbols used for SRS 305). The SRS 305 can be transmitted anywhere in the UL slot 303.

FIG. 3B illustrates another example where the antenna switching symbols 317a and 317b (e.g., the transient periods) can be any time before and after the SRS 315. In this example, an UL slot 313 is illustrated that includes 14 symbols illustrated as symbol 0 to symbol 13. In this example, the UE can transmit the SRS 315 during symbols 10 and 11. The UE is using a first antenna (e.g., a first antenna port) during symbols 0 through symbol 6. During the symbol 7 317a, the UE switches to a second antenna (e.g., a second antenna port) that is different from the first antenna. The UE transmits the SRS 315 using the second antenna during symbols 10 and 11. During symbol 13 317b, the UE switches to a third antenna (e.g., a third antenna port). According to some aspects, the third antenna is the same as the first antenna. After symbol 13 317b, the UE uses the third antenna for UL transmission.

FIG. 3C illustrates another example where the antenna switching symbols 327a and 327b (e.g., the transient periods) are immediately before and after the SRS 325. In other words, the antenna switching symbols 327a and 327b are contiguous with the symbol(s) used for the transmission of the SRS 325. In this example, an UL slot 323 is illustrated that includes 14 symbols illustrated as symbol 0 to symbol 13. In this example, the UE can transmit the SRS 325 during symbols 11 and 12. The UE is using a first antenna (e.g., a first antenna port) during symbols 0 through symbol 9. During the symbol 10 327a, the UE switches to a second antenna (e.g., a second antenna port) that is different from the first antenna. The UE transmits the SRS 325 using the second antenna during symbols 11 and 12. During symbol 13 327b, the UE switches to a third antenna (e.g., a third antenna port). According to some aspects, the third antenna is the same as the first antenna. After symbol 13 327b, the UE uses the third antenna for UL transmission. In this example, the UE can use symbol 0 to symbol 5 for PUSCH.

It is noted that FIGS. 3A-3C are provided as examples. Other number of symbols and/or other configurations for antenna switching and/or SRS transmission can be used. Also, although symbols (e.g., OFDM symbols) in slots (e.g., time slots) are illustrated as resources used by the UE for antenna switching and/or SRS transmission, other resources (e.g., resources in the frequency domain) can be used by the UE for antenna switching and/or SRS transmission.

According to some aspects, the UE can use an indication message (e.g., one or more of RRC message(s), MAC-CE, and/or UCI) to communicate to the base station an indication of the symbols 307a, 317a, 327a, 307b, 317b, and 327b during which the UE is performing antenna switching for the SRS. Accordingly, the base station can determine that the UE is not available during the symbols 307a, 317a, 327a, 307b, 317b, and 327b. Based on this determination, the base station can define scheduling restriction for the symbols 307a, 317a, 327a, 307b, 317b, and 327b, rather than slot level interruption. For example, the base station can refrain from transmitting and/or scheduling DL transmission during the symbols 307a, 317a, 327a, 307b, 317b, and 327b. Additionally, or alternatively, the base station can refrain from scheduling UL transmission for the UE during the symbols 307a, 317a, 327a, 307b, 317b, and 327b. The base station can schedule other symbols for UL transmission and/or DL transmission.

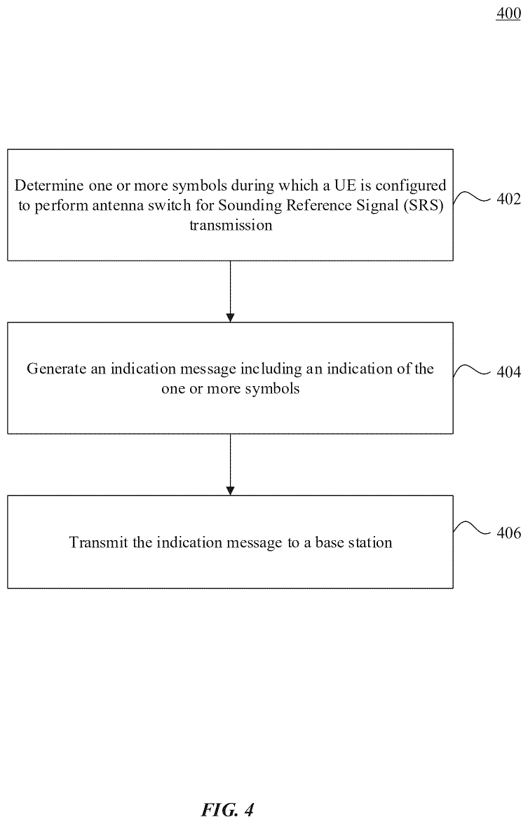

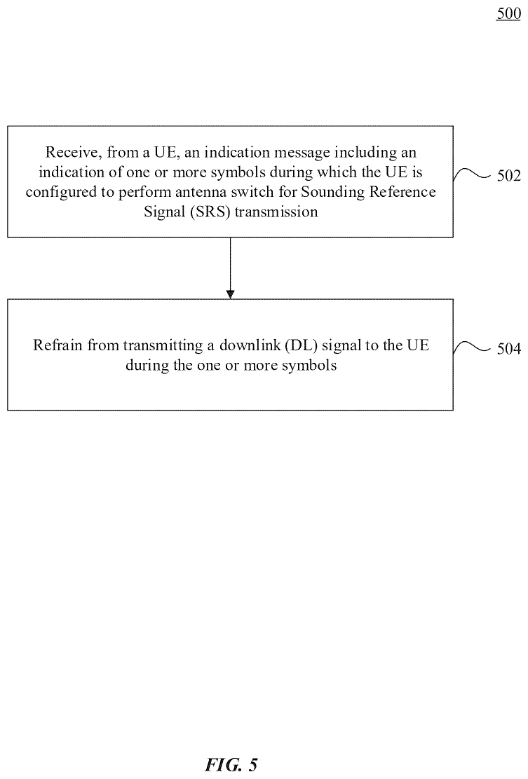

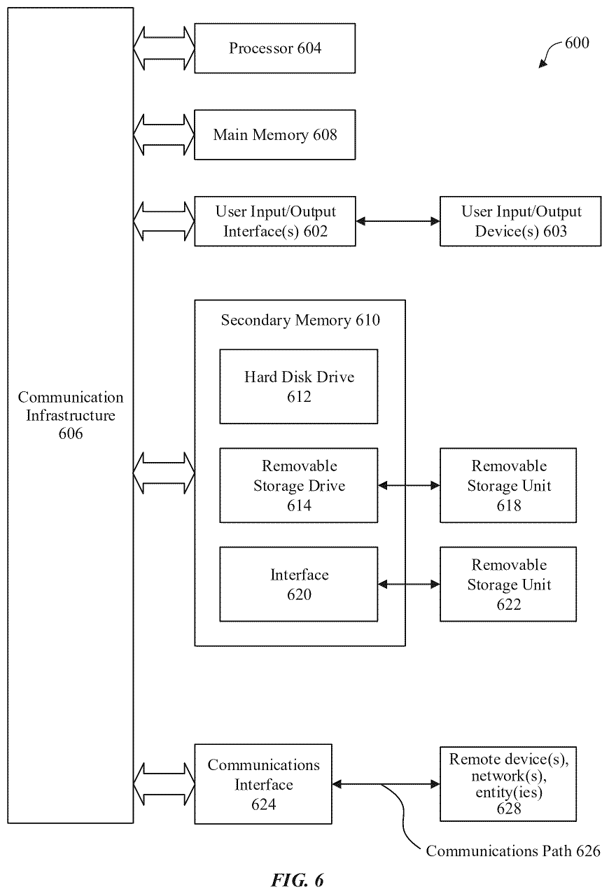

FIG. 4 illustrates an example method 400 for a system (for example, a UE) supporting mechanisms for RRM enhancements for SRS antenna switching, according to some aspects. As a convenience and not a limitation, FIG. 4 may be described with regard to elements of FIGS. 1-3. Method 400 may represent the operation of an electronic device (for example, UE 105 of FIG. 1) implementing mechanisms for RRM enhancements for SRS antenna switching. Method 400 may also be performed by system 200 of FIG. 2 and/or computer system 600 of FIG. 6. But method 400 is not limited to the specific aspects depicted in those figures and other systems may be used to perform the method as will be understood by those skilled in the art. It is to be appreciated that not all operations may be needed, and the operations may not be performed in the same order as shown in FIG. 4.

At 402, one or more symbols are determined during which the UE is configured to perform antenna switch for Sounding Reference Signal (SRS) transmission. For example, the UE (e.g., the UE 105) can determine the one or more symbols during which the UE is configured to perform antenna switch for SRS transmission. For example, the UE can determine the one or more symbols based on UE capability, TX/RX configurations, and/or TX/RX antenna configurations. The UE can additionally use information about the one or more SRS transmission occasions to determine the one or more symbols the UE uses for antenna switching for SRS transmission. Although one or more symbols are discussed during which the UE is configured to perform antenna switch for SRS transmission, in 402 the UE can determine other resources that the UE uses for antenna switching for SRS transmission.

At 404, an indication message is generated that includes an indication of the one or more symbols that are used for antenna switching for SRS transmission. For example, the UE can generate the indication message that includes the indication of the one or more symbols that are used for antenna switching for SRS transmission. The one or more symbols can be identified in terms of respective symbol location(s) within a slot, as shown in FIGS. 3A-3C. The indication message can include the indication of other resources that the UE uses for antenna switching for SRS transmission. In some aspects, the indication message includes at least one of a Radio Resource Control (RRC) message, a Medium Access Control (MAC) Control Element (MAC-CE), or a Uplink Control Information (UCI).

The indication of the one or more symbols can identify one or more symbols before the SRS transmission during which the UE is configured to perform the antenna switch. Additionally, or alternatively, the indication can identify one or more symbols after the SRS transmission during which the UE is configured to perform the antenna switch. The one or more symbols can be identified in terms of respective symbol location(s) within a slot, as shown in FIGS. 3A-3C. Additionally, or alternatively, the indication can include a symbol level bitmap for identifying the one or more symbols during which the UE is configured to perform the antenna switch.

Additionally, or alternatively, the indication can include two or more antenna switching patterns. The UE can determine the patterns based on a number of SRS symbols of the SRS transmission and a start symbol the SRS transmission. In some examples where different switching patters are used, the indication message that the UE generates can include, for example, an RRC message indicating that the UE having two or more antenna switching patterns and one or more of a MAC-CE or a UCI indicating a specific antenna switching pattern.

At 406, the indication message is transmitted to the base station. For example, the UE can transmit the indication message to the base station.

In some aspects, the method 400 can further include switching from a first antenna to a second antenna during a first set of symbols of the one or more symbols, using the second antenna for the SRS transmission, and switching to the first antenna during a second set of symbols of the one or more symbols. In other words, the determined one or more symbols during which the UE is configured to perform antenna switch for SRS transmission can include the first set of symbols before the SRS transmission and the second set of symbols after the SRS transmission. The first set of symbols can have one or more symbols. The second set of symbols can have one or more symbols. The first and second sets of symbols have the same or different number of symbol(s). During the first set of symbols, the UE can switch from the first antenna to the second antenna (that is different from the first antenna). The UE can use the second antenna to transmit the SRS. The UE can then switch back to the first antenna (or to a third antenna different from the first and second antennas) during the second set of symbols after the SRS transmission.

FIG. 5 illustrates an example method 500 for a system (for example, a base station) supporting mechanisms for RRM enhancements for SRS antenna switching, according to some aspects. As a convenience and not a limitation, FIG. 5 may be described with regard to elements of FIGS. 1-4. Method 500 may represent the operation of an electronic device (for example, the base station 101 of FIG. 1) implementing mechanisms for RRM enhancements for SRS antenna switching. Method 500 may also be performed by system 200 of FIG. 2 and/or computer system 600 of FIG. 6. But method 500 is not limited to the specific aspects depicted in those figures and other systems may be used to perform the method as will be understood by those skilled in the art. It is to be appreciated that not all operations may be needed, and the operations may not be performed in the same order as shown in FIG. 5.

At 502, an indication message is received. For example, a base station (e.g., the base station 101 of FIG. 1) receives the indication message from a UE (e.g., the UE 105 of FIG. 1). The indication message can include an indication of one or more symbols during which the UE is configured to perform antenna switch for Sounding Reference Signal (SRS) transmission. Using the indication message, the base station can determine the one or more symbols during which the UE is not available for DL or UL transmission because the UE is performing antenna switch for SRS transmission.

At 504, the base station refrains from transmitting a downlink (DL) signal to the UE during the one or more symbols. The base station can refrain from transmitting and/or scheduling DL transmission during the one or more symbols. Additionally, or alternatively, the base station can refrain from scheduling UL transmission for the UE during the one or more symbols. The base station can schedule other symbols (other than the one or more symbols) for UL transmission and/or DL transmission.

According to some aspects, the base station can use (e.g., during 502) the indication of the one or more symbols and timing advance information to determine the one or more symbols for refraining from transmitting DL signal(s) to the UE. For example, as discussed above, the indication of the one or more symbols can identify one or more symbols before the SRS transmission during which the UE is configured to perform the antenna switch, one or more symbols after the SRS transmission during which the UE is configured to perform the antenna switch, a symbol level bitmap, and/or a plurality of patterns. The one or more symbols can be identified in terms of respective symbol location(s) within a slot, as shown in FIGS. 3A-3C. Additionally, since the UL and DL transmissions may have a time difference based on the timing advance information, the base station uses the timing advance information (e.g., the timing adjustment 302) to determine the one or more symbols. In other words, the base station can use both the indication of the one or more symbols and the timing advance information to determine the one or more symbols that the UE is unavailable because of the SRS antenna switching. In a non-limiting example, the base station can add the timing advance information to the indication of the one or more symbols (from the indication message) to determine the one or more symbols that the UE is unavailable because of the SRS antenna switching.

Various aspects can be implemented, for example, using one or more computer systems, such as computer system 600 shown in FIG. 6. Computer system 600 can be any well-known computer capable of performing the functions described herein such as devices 101, 105 of FIG. 1, and/or 200 of FIG. 2. Computer system 600 includes one or more processors (also called central processing units, or CPUs), such as a processor 604. Processor 604 is connected to a communication infrastructure 606 (e.g., a bus). Computer system 600 also includes user input/output device(s) 603, such as monitors, keyboards, pointing devices, etc., that communicate with communication infrastructure 606 through user input/output interface(s) 602. Computer system 600 also includes a main or primary memory 608, such as random access memory (RAM). Main memory 608 may include one or more levels of cache. Main memory 608 has stored therein control logic (e.g., computer software) and/or data.

Computer system 600 may also include one or more secondary storage devices or memory 610. Secondary memory 610 may include, for example, a hard disk drive 612 and/or a removable storage device or drive 614. Removable storage drive 614 may be a floppy disk drive, a magnetic tape drive, a compact disk drive, an optical storage device, tape backup device, and/or any other storage device/drive.

Removable storage drive 614 may interact with a removable storage unit 618. Removable storage unit 618 includes a computer usable or readable storage device having stored thereon computer software (control logic) and/or data. Removable storage unit 618 may be a floppy disk, magnetic tape, compact disk, DVD, optical storage disk, and/any other computer data storage device. Removable storage drive 614 reads from and/or writes to removable storage unit 618 in a well-known manner.

According to some aspects, secondary memory 610 may include other means, instrumentalities or other approaches for allowing computer programs and/or other instructions and/or data to be accessed by computer system 600. Such means, instrumentalities or other approaches may include, for example, a removable storage unit 622 and an interface 620. Examples of the removable storage unit 622 and the interface 620 may include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

Computer system 600 may further include a communication or network interface 624. Communication interface 624 enables computer system 600 to communicate and interact with any combination of remote devices, remote networks, remote entities, etc. (individually and collectively referenced by reference number 628). For example, communication interface 624 may allow computer system 600 to communicate with remote devices 628 over communications path 626, which may be wired and/or wireless, and which may include any combination of LANs, WANs, the Internet, etc. Control logic and/or data may be transmitted to and from computer system 600 via communication path 626.

The operations in the preceding aspects can be implemented in a wide variety of configurations and architectures. Therefore, some or all of the operations in the preceding aspects may be performed in hardware, in software or both. In some aspects, a tangible, non-transitory apparatus or article of manufacture includes a tangible, non-transitory computer useable or readable medium having control logic (software) stored thereon is also referred to herein as a computer program product or program storage device. This includes, but is not limited to, computer system 600, main memory 608, secondary memory 610 and removable storage units 618 and 622, as well as tangible articles of manufacture embodying any combination of the foregoing. Such control logic, when executed by one or more data processing devices (such as computer system 600), causes such data processing devices to operate as described herein.

Based on the teachings contained in this disclosure, it will be apparent to persons skilled in the relevant art(s) how to make and use aspects of the disclosure using data processing devices, computer systems and/or computer architectures other than that shown in FIG. 6. In particular, aspects may operate with software, hardware, and/or operating system implementations other than those described herein.

It is to be appreciated that the Detailed Description section, and not the Summary and Abstract sections, is intended to be used to interpret the claims. The Summary and Abstract sections may set forth one or more, but not all, exemplary aspects of the disclosure as contemplated by the inventor(s), and thus, are not intended to limit the disclosure or the appended claims in any way.

While the disclosure has been described herein with reference to exemplary aspects for exemplary fields and applications, it should be understood that the disclosure is not limited thereto. Other aspects and modifications thereto are possible, and are within the scope and spirit of the disclosure. For example, and without limiting the generality of this paragraph, aspects are not limited to the software, hardware, firmware, and/or entities illustrated in the figures and/or described herein. Further, aspects (whether or not explicitly described herein) have significant utility to fields and applications beyond the examples described herein.

Aspects have been described herein with the aid of functional building blocks illustrating the implementation of specified functions and relationships thereof. The boundaries of these functional building blocks have been arbitrarily defined herein for the convenience of the description. Alternate boundaries can be defined as long as the specified functions and relationships (or equivalents thereof) are appropriately performed. In addition, alternative aspects may perform functional blocks, steps, operations, methods, etc. using orderings different from those described herein.

References herein to “one aspect,” “aspects” “an example,” “examples,” or similar phrases, indicate that the aspect(s) described may include a particular feature, structure, or characteristic, but every aspect may not necessarily include the particular feature, structure, or characteristic. Moreover, such phrases are not necessarily referring to the same aspect. Further, when a particular feature, structure, or characteristic is described in connection with an aspect, it would be within the knowledge of persons skilled in the relevant art(s) to incorporate such feature, structure, or characteristic into other aspects whether or not explicitly mentioned or described herein.

The breadth and scope of the disclosure should not be limited by any of the above-described exemplary aspects, but should be defined only in accordance with the following claims and their equivalents.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users, and should be updated as the collection and/or use of data changes. Personal information from users should be collected for legitimate and reasonable uses of the entity and not shared or sold outside of those legitimate uses. Further, such collection/sharing should only occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the US, collection of, or access to, certain health data may be governed by federal and/or state laws, such as the Health Insurance Portability and Accountability Act (HIPAA); whereas health data in other countries may be subject to other regulations and policies and should be handled accordingly. Hence different privacy practices should be maintained for different personal data types in each country.

What is claimed is:

1. A user equipment (UE), comprising:
a transceiver configured to enable wireless communication with a base station; and
a processor communicatively coupled to the transceiver and configured to:
determine one or more symbols during which the UE is configured to perform an antenna switch for a Sounding Reference Signal (SRS) transmission;
generate an indication message including an indication of the one or more symbols; and
transmit, using the transceiver, the indication message to the base station.

2. The UE of claim 1, wherein the indication message comprises at least one of a Radio Resource Control (RRC) message, a Medium Access Control (MAC) Control Element (MAC-CE), or a Uplink Control Information (UCI).

3. The UE of claim 1, wherein the indication identifies one or more symbols before the SRS transmission during which the UE is configured to perform the antenna switch.

4. The UE of claim 1, wherein the indication identifies one or more symbols after the SRS transmission during which the UE is configured to perform the antenna switch.

5. The UE of claim 1, wherein the indication comprises a symbol level bitmap for indicating the one or more symbols during which the UE is configured to perform the antenna switch.

6. The UE of claim 1, wherein the processor is further configured to:
switch from a first antenna to a second antenna during a first set of symbols of the one or more symbols;
use the second antenna for the SRS transmission; and
switch to the first antenna during a second set of symbols of the one or more symbols.

7. The UE of claim 1, wherein the indication comprises two or more antenna switching patterns based on a number of SRS symbols of the SRS transmission and a start symbol the SRS transmission.

8. The UE of claim 7, wherein the indication message comprises:
a Radio Resource Control (RRC) message indicating that the UE having two or more antenna switching patterns, and
one or more of a Medium Access Control (MAC) Control Element (MAC-CE) or a Uplink Control Information (UCI) indicating a specific antenna switching pattern of the two or more antenna switching patterns.

9. A method, comprising:
determining one or more symbols during which a user equipment (UE) is configured to perform an antenna switch for a Sounding Reference Signal (SRS) transmission;
generating an indication message including an indication of the one or more symbols; and
transmitting the indication message to a base station.

10. The method of claim 9, wherein the indication message comprises at least one of a Radio Resource Control (RRC) message, a Medium Access Control (MAC) Control Element (MAC-CE), or a Uplink Control Information (UCI).

11. The method of claim 9, wherein the indication identifies one or more symbols before the SRS transmission during which the UE is configured to perform the antenna switch.

12. The method of claim 9, wherein the indication one or more symbols after the SRS transmission during which the UE is configured to perform the antenna switch.

13. The method of claim 9, wherein the indication comprises a symbol level bitmap for indicating the one or more symbols during which the UE is configured to perform the antenna switch.

14. The method of claim 9, further comprising:
switching from a first antenna to a second antenna during a first set of symbols of the one or more symbols;
using the second antenna for the SRS transmission; and
switching to the first antenna during a second set of symbols of the one or more symbols.

15. The method of claim 9, wherein the indication comprises two or more antenna switching patterns based on a number of SRS symbols of the SRS transmission and a start symbol the SRS transmission.

16. The method of claim 15, wherein the indication message comprises:
a Radio Resource Control (RRC) message indicating that the UE having two or more antenna switching patterns, and
one or more of a Medium Access Control (MAC) Control Element (MAC-CE) or a Uplink Control Information (UCI) indicating a specific antenna switching pattern of the two or more antenna switching patterns.

17. A non-transitory computer-readable medium storing instructions that, when executed by a processor of a user equipment (UE), cause the UE to perform operations comprising:
determining a plurality of symbols during which the UE is configured to perform an antenna switch for a Sounding Reference Signal (SRS) transmission;
generating an indication message including an indication of the plurality of symbols; and
transmitting the indication message to a base station.

18. The non-transitory computer-readable medium of claim 17, wherein the indication comprises two or more antenna switching patterns based on a number of SRS symbols of the SRS transmission and a start symbol the SRS transmission and wherein the indication message comprises:
a Radio Resource Control (RRC) message indicating that the UE having two or more antenna switching patterns, and
one or more of a Medium Access Control (MAC) Control Element (MAC-CE) or a Uplink Control Information (UCI) indicating a specific antenna switching pattern of the two or more antenna switching patterns.

19. The non-transitory computer-readable medium of claim 17, the operations further comprising:
switching from a first antenna to a second antenna during a first set of symbols of the plurality of symbols;
using the second antenna for the SRS transmission; and
switching to the first antenna during a second set of symbols of the plurality of symbols.

20. The non-transitory computer-readable medium of claim 17, wherein the indication comprises:
one or more symbols before the SRS transmission and one or more symbols after the SRS transmission during which the UE is configured to perform the antenna switch, or
a symbol level bitmap for indicating the plurality symbols during which the UE is configured to perform the antenna switch.
